(19) United States
(12) Patent Application Publication
(10) Pub. No.: US 2005/0210506 A1
(43) Pub. Date: Sep. 22, 2005

(54) Controlling the content of a personalized visual channel

(75) Inventor: Eugenie Irma Benliyan, Rotterdam (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/518,836

(22) PCT Filed: Jun. 12, 2003
(86) PCT No.: PCT/IB03/02741

§ 371 Date: Dec. 21, 2004

(30) Foreign Application Priority Data
Jun. 27, 2002 (EP) 02077570.6

(51) Int. Cl. H04N 7/025; H04N 5/445; G06F 13/00; G06F 3/00; H04N 7/10; H04N 7/087; H04N 7/084

(52) U.S. Cl. 725/46; 348/473; 725/34; 725/35

(57) ABSTRACT

A system provides a personalized visual channel for a user based on visual input received from other users, while the user him/herself also provides visual information. The users are connected via a network (14), and the personalized visual channel may be generated in a server entity (15). For controlling the content of the channel relationship information is maintained that is indicative of a relational distance between the user and other users. The channel shows a wheel-like visual structure (45) that has a home element (40) visually representing a home location of the user, and other user elements (41, 42, 43, 44). The user elements are positioned at a distance from the home element in dependence on the relationship information. The user controls the structure via a local remote control unit having specific visual control functions.

The invention relates to a system and method for controlling the content of a personalized visual channel.

The invention further relates to a device for cooperating with the system.

The invention further relates to a computer program product for controlling the content of a personalized visual channel.

Using the available networks like internet or the TV cable system it is possible for a user to acquire a lot of visual content for displaying a visual channel on a screen of the PC or TV. The well known television system (TV) provides many TV channels giving entertainment for users by showing movies, news, shows, quizzes, etc. Usually content is intended to be watched actively. Further the TV provides music channels which more or less continuously show music clips. Many people use the TV not only for actively watching, but leave the TV switched on for background use while they are doing other things. Selecting the content of the visual channel may be facilitated by an overview channel showing a number of small size images from the other TV channels. Depending on the selected network the user has the option of further controlling the content of a visual channel. Users may be supplying visual information, e.g. a graphical picture, digital photograph or video, or a constructed website page. The use of capture units, usually called web cams, is known from the internet. For example DE 100 34 192 shows a security system using remote cameras connected to a computer via e-mail. For watching the real time information of a web cam the user is required to have a computer and so-called browser software, and needs to search the internet to find the location of a web cam. For example via the internet it is possible to have views of many inside or outside locations supplied by users via web cams. The web cams can be accessed via websites showing links to such web cams, usually by showing one or more small size pictures showing the visual content supplied by the web cam. However selecting the content of a visual channel based on the overview or website link pages is not convenient for a user.

Therefore it is an object of the invention to provide a system and method for controlling the content of a personalized visual channel which increases the control of the user over the selectable visual content.

According to a first aspect of the invention the object is achieved with a system for controlling content of a personalized visual channel for at least one of a number of users, the users supplying visual information and being linkable via a network, which system comprises relationship means for maintaining relationship information that is indicative of a relational distance between the user and other users, structure means for providing a visual structure for display within the personalized visual channel, the visual structure comprising a home element representing a home location of the user, and user elements, each user element representing one of the other users by said supplied visual information, the user elements being positioned at a distance from the home element in dependence on the relationship information, and control means for receiving user commands for controlling the structure means.

According to a second aspect of the invention the object is achieved with a device for providing a personalized visual channel for at least one of a number of users, the users supplying visual information and being linkable via a network, for cooperating with the system as described above, the device comprising an input unit for receiving real time information from a capture unit, which real time information comprises video information related to the user, in particular video information from a web cam, storage means for storing user parameters identifying the user, user control means for receiving user commands for controlling structure means for generating a visual structure for display within the personalized visual channel, the visual structure comprising a home element representing a home location of the user, and user elements, each user element representing one of the other users by said supplied visual information, the user elements being positioned in the visual structure at a distance from the home element in dependence on the relationship information, a network unit for coupling the device to the system via a network for transmitting the real time information and the user parameters and user commands and for receiving the personalized visual channel, and generating means for generating an output signal for display of the personalized visual channel.

According to a third aspect of the invention the object is achieved with a method of controlling content of a personalized visual channel for at least one of a number of users, the users supplying visual information and being linkable via a network, which method comprises maintaining relationship information that is indicative of a relational distance between the user and other users, providing a visual structure for display within the personalized visual channel, the visual structure comprising a home element representing a home location of the user, and user elements, each user element representing one of the other users by said supplied visual information, the user elements being positioned in the visual structure at a distance from the home element in dependence on the relationship information, and receiving user commands for controlling the visual structure.

According to a fourth aspect of the invention the object is achieved with a computer program product for performing the method.

The effect of providing the visual structure is that the user has a visual feedback of the relationship of the user to the available visual content. The relationship information is transferred to a relational distance, which is used to determine the position in the visual structure of the user elements in relation to the home element. Hence the visual structure is a personalized overview of the available visual sources. By navigating through the visual structure the user can easily control the display of the visual structure, and by selectively issuing user commands he can control the overall content of the personalized visual channel.

In an embodiment of the system the relationship means are arranged for receiving the relationship information from the user based on an acquaintance between the user and said other user, and/or for establishing at least one next level of relational distance based on the relationship information supplied by other users, and/or for applying the relationship information provided by the user for establishing the relationship information for an inverse relation of said other user to the user. This has the advantage that the user actively supplies and controls the relationship information which determines a relational network of many users having a relational distance, which relational network is correspondingly translated in the visual structure. In particular it is noted that using the list of acquaintances of a user as a first degree of relational distance, and the acquaintances of the acquaintances of the user as a second degree, etc. provides a high probability that in a few levels a large number of users are present within the levels of the visual structure. It is believed that six levels are generally sufficient to reach substantially every possible user.

In an embodiment of the system the structure means are arranged for creating at least one substantially annular area of user elements around a centrally located home element, the radial distance between the home element and the annular area corresponding to the relational distance. This has the advantage that the radial distance conceptually corresponds to the degree of relationship that the user has to the user elements of the other users. Further the user elements within the annular area can be easily selected by the user by simple user commands. It is noted that annular does not necessarily imply circular, but annular area should be interpreted as a closed band of visual information going around the home element, subdivided according to the number of user elements at a certain relational distance. For example such annular bands may also be rectangular.

Further preferred embodiments of the device and server entity according to the invention are given in the further claims.

These and other aspects of the invention will be apparent from and elucidated further with reference to the embodiments described by way of example in the following description and with reference to the accompanying drawings, in which

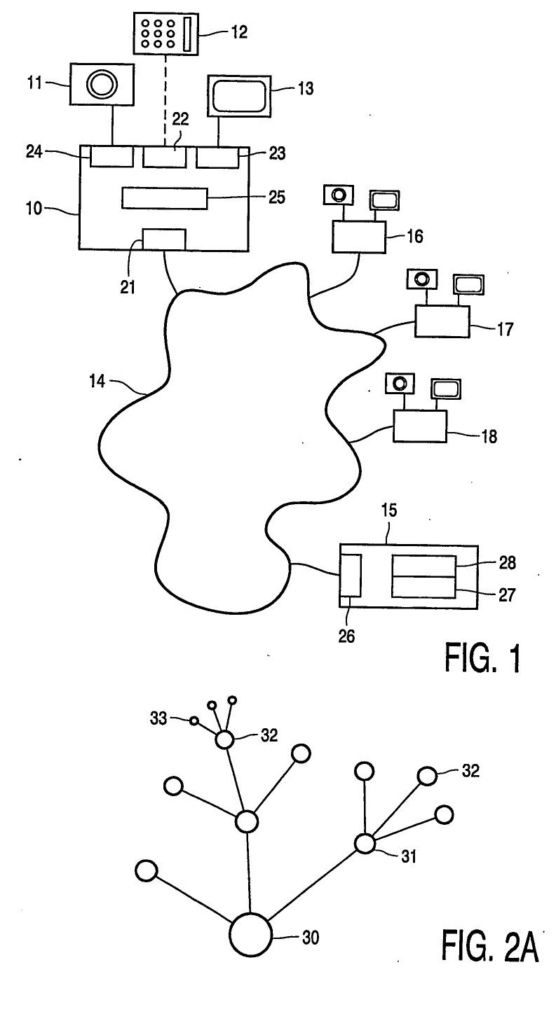

FIG. 1 shows a network, a server and user devices,

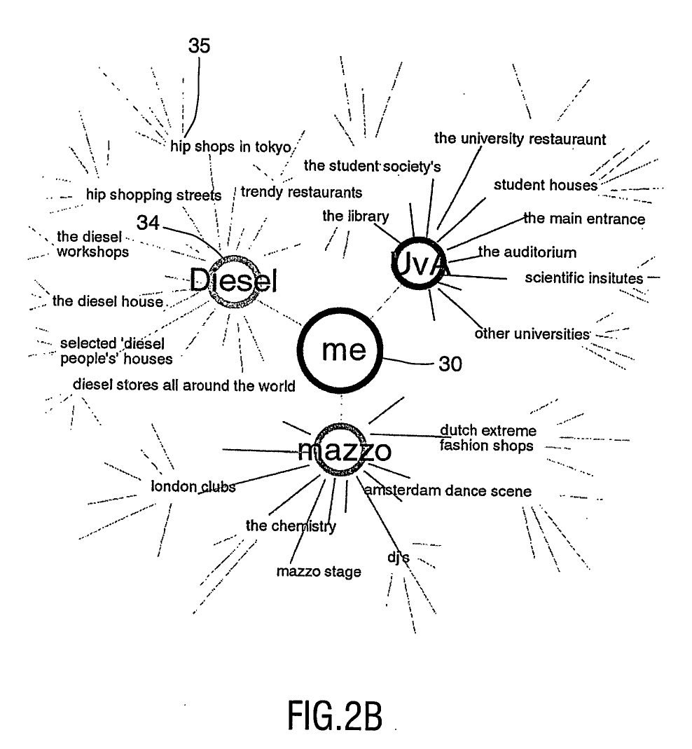

FIG. 2a and 2b show relationship information,

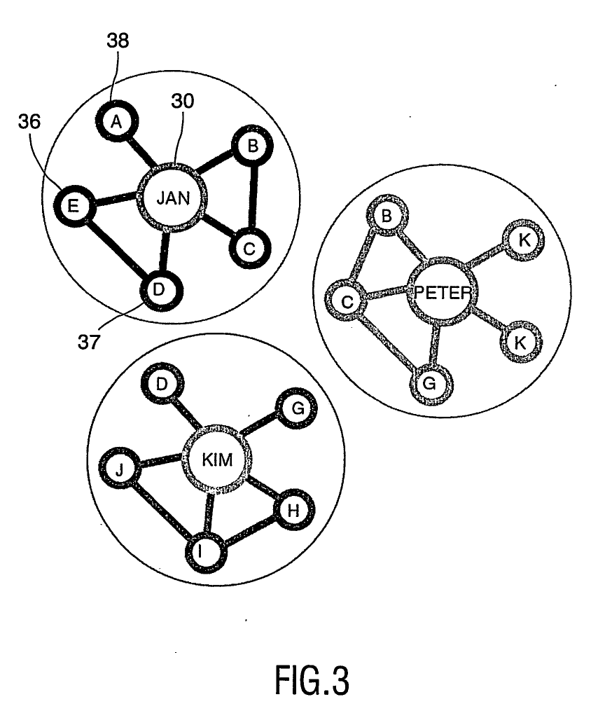

FIG. 3 shows a closed relationship network,

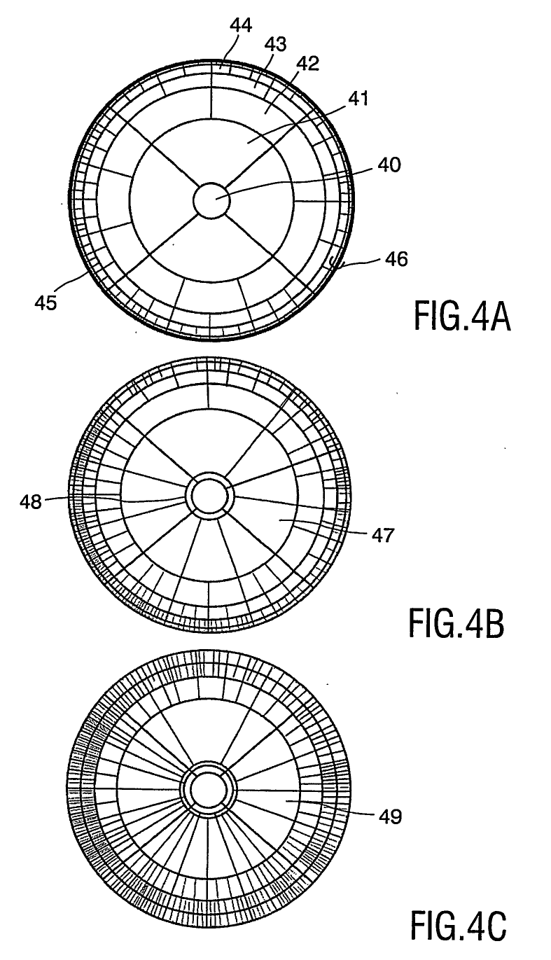

FIG. 4a, 4b and 4c show visual structures for a personalized channel,

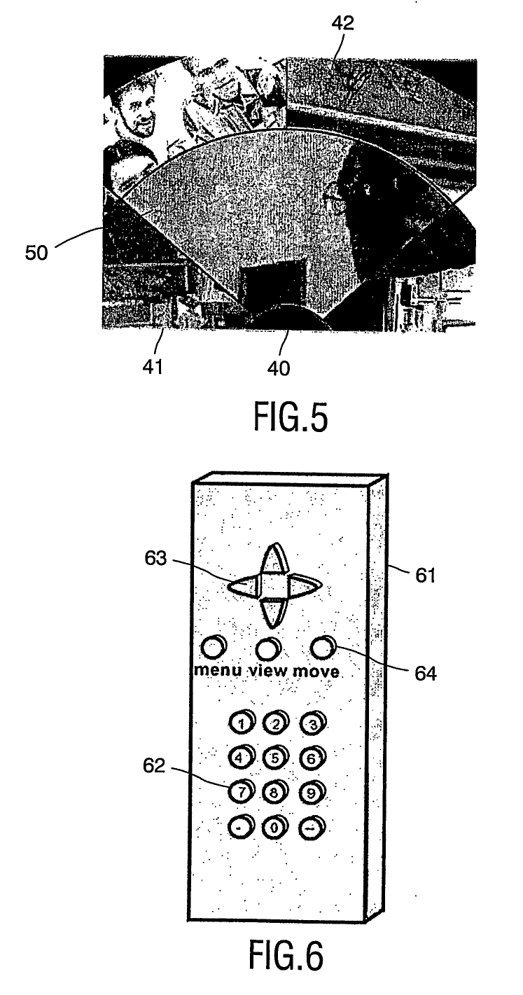

FIG. 5 shows a segment of a visual structure,

FIG. 6 shows a user command unit,

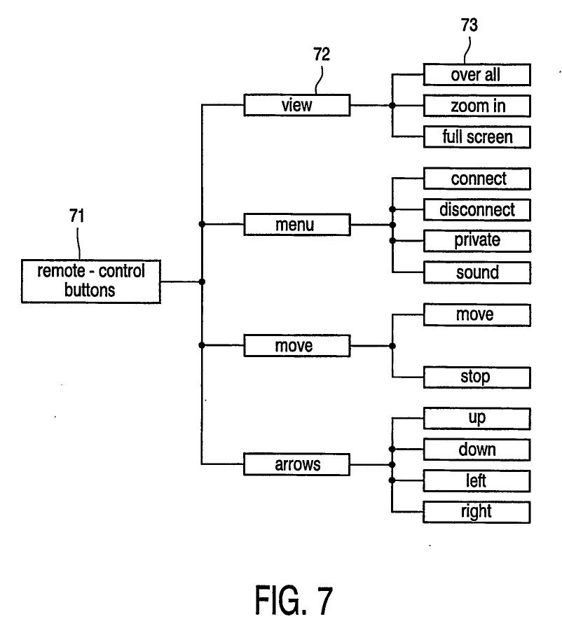

FIG. 7 shows user command functions, and

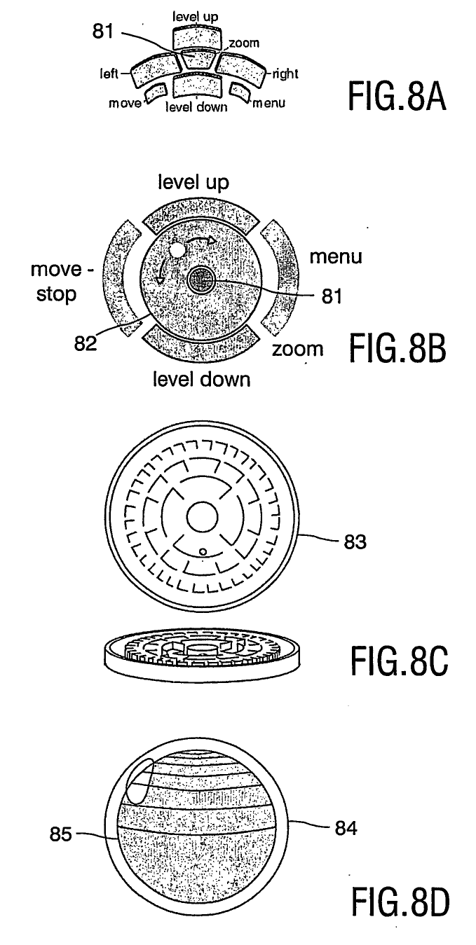

FIG. 8a, 8b, 8c and 8d show alternative sets of user command buttons.

In the Figures, elements which correspond to elements already described have the same reference numerals.

FIG. 1 shows a network, a server and user devices. The Figure schematically shows a network 14, e.g. the internet, and a number of devices connected via the network. A first user device 10 for providing a personalized visual channel to a user is coupled to the network. The device 10 has an input unit 24 for receiving real time information from a capture unit 11, which real time information comprises video information related to the user. The real time information may include sound, or further parameters detected like room temperature. A suitable capture unit for generating video information is a web cam. The capture unit may also have a microphone for capturing sound, and a switch for controlling the microphone. In an embodiment the input unit 24 provides a wireless connection to the capture unit. The input unit 24 may in addition have a detector for detecting the presence of sound, and provide the detection result to the user control unit 22 for further control of the personalized TV channel. The device 10 further has a memory 25 for storing user parameters identifying the user, a control unit 22 for receiving user commands for controlling the contents of the personalized channel. The user commands may be entered via a remote control unit 12. The device has a network unit 21 for coupling the device to a server entity via the network 14 for transmitting the real time information and the user parameters and user commands and for receiving the personalized channel, and a generating unit 23 for generating an output signal for display on a display 13 based on the personalized channel. Further user devices 16, 17, 18 are also coupled via the network 14. The further user devices are similar to the first user device 10. Each user has a display unit and personal parameters for connecting to the network. In an embodiment one user device has input circuitry for connecting several capture units, and/or output circuitry for generating several output signals, whereas the memory and control is arranged for handling the personal parameters and the personalized visual channel for several users.

A server entity 15 is also coupled via the network 14 for providing a personalized channel for each of a number of users, as far as the respective user is actively connected and requires such a personalized channel. The server entity 15 has a network unit 26 for receiving real time information, user parameters and user commands via the network and for transmitting the personalized channel to the user via the network, and a generation unit 27 for generating the personalized channel for said at least one user in response to the user parameters and user commands by selectively including in the personalized channel real time information from fisher users. In an embodiment of the server the generation unit 27 comprises a visual structure unit for generating a visual structure as described below with reference to FIGS. 4 and 5.

In an embodiment of the system the visual structure itself is generated in the user device generating unit 23. The server then only supplies the visual information for display in the user elements. In an embodiment the server facilitates setting up a link from the user's device via the network to the respective other user devices. The video and/or audio information is transmitted via the link directly between the user devices. The user device may request video information from user elements that are displayed relatively large in the visual structure more often than video information for user elements that are displayed relatively small. In addition the user device may request some video information from the server, and request other video information via a direct link to the other user, in particular for displaying a user element that has to be actively displayed on a large area of the display screen and has the attention of the user.

In an embodiment of the system the functionality of the server entity is implemented in the user devices. The server entity within each user device performs the functions of maintaining the relationship information for the user of that device, and maintaining some further relationship information for constructing the personalized visual channel and connecting to other user devices. A network of relationship information is constructed by the server entity within the user device, and extended by connecting to other server entities in other user devices and exchanging relationship information. In an embodiment the system is implemented in a software program running on a suitably equipped PC, the PC having an input unit for connecting a video camera (web cam) and a network unit.

Relationship information for constituting the personalized visual channel as described below with reference to FIGS. 2 and 3 may be maintained in the user device, or at least part of the relationship information may be maintained in the server. In an embodiment the server comprises a relationship unit 28 for maintaining relationship information and calculating relational distance. Relationship information may be entered by the users themselves via the user command unit 22. In addition a system operator can enter and maintain the relationship information directly on the server 15. Relational distance calculation is performed in relationship unit 28 according to the parameters as discussed below. A suitable relationship distance is based on the circle of acquaintances of a user to be set as the first degree, and the acquaintances of each acquaintance as a second degree, etc. It is believed that in six degrees substantially all users in the world can be reached. Generation unit 27 generates the personalized channel using real time information received from further users selected in dependence on said transmitted user parameters and user commands. Creating the content of the personalized visual channel is described in detail below with reference to FIGS. 2, 3, 4 and 5. It is to be noted that the personalized visual channel is created individually for each user requesting the service, although parts of the image of different personalized channels may be derived from the same source, and therefore correspond. Each individually created channel is transferred via the network to the respective user only, e.g. by using well known transmission techniques such as internet.

Basically the system is a new network connecting users via images provided by the users themselves. What the users show is up to them, it could be any thing ranging from themselves, their gardens, their pets, or just their blank walls. The system gives users the chance of just showing something of themselves, and seeing other users. The fact that one can see the personalized visual channel on TV makes it something relaxed and informal. In a first example a completely ambient and passive use is foreseen. A girl is just sitting in her living room and reading. The personalized channel on her TV shows a different room, and later a girlfriend appears in that room.

In a second example the system is used as a new communication device. The girl is again reading in her living room. The user device is arranged for signaling that another user is connecting, e.g. by a visual signal on the display or an audio signal. The girl switches the sound on, and communicates with the newly connected user. They decide to watch the TV channel, and have a small ‘picture-in-picture’ frame still showing each other in the personalized channel.

Basic functions for managing the system of personalized channels are the following. Logging in-out of user requires that the server knows the identity of the user. A new user gets an ID-number, for example when a product is bought, or the user starts participating by subscribing. The server keeps status information, for example knowing when a user is logged in, or to whom a user is connected to. In an embodiment a user has to make video information available before he can receive the personalized channel, i.e. one can't be online ‘invisible’. The server maintains relationship information, e.g. a preference list of friends. In an embodiment the first degree is two-sided; one is automatically in each other's first degree. Alternatively users are in each others first degree when both enter each others ID-number. The server also provides searching functions for the user. For example a user can zap around in different levels, but not search specifically (like searching for names or exact addresses). In an embodiment searching is performed by an automatic zap. The speed of the zap function may depend on what layer one is in (layer one, the closest to the user, is the slowest, layer six is the fastest). Further a user may be searched by direct parameters like the ID-number.

FIGS. 2a and 2b show relationship information. FIG. 2a shows a home element 30 called ‘me’ representing the user. The first level of relationship is indicated by first degree user elements 31. The relationship of the first degree user elements 31 to second degree user elements 32 is indicated one level further away from the home element 30. Third degree user elements 33 are again one level further away from the home element 30. As shown the users make living communities by putting their friends and family in the first degree, and through them they can reach other users. It is noted that using such a network of relations in six levels substantially all users of the system will be reachable. FIG. 2b shows a relationship diagram of a different type of users, based on commercial and entertainment interest of the user, or the mood of a user at a specific moment. The user can get access to such an interest group via an access portal such as indicated on the second level 34, e.g. commercial entity users. The third level users 35 are based on the (commercial) interest parameter of the respective second level interest oriented users 34. In an embodiment users would have to pay to get into certain places, or would enter via advertisements, so it is known what the most popular places are. Hence advertisers know how to find spots where they can reach people to sell products. For example, the personalized channel could become commercial with certain businesses opening the door to places where the user otherwise would never come as shown in FIG. 2b. The Figure shows examples of users like UvA (University of Amsterdam), Mazzo (club in Amsterdam), or Diesel (a clothes brand). In an embodiment other navigation systems as described below are made available, so the user can choose one system depending on his/or needs or mood. The navigation systems could also become more complex; maybe learning what the user likes, or depending on sound and emotions in the room.

FIG. 3 shows a closed relationship network. The home element 30 represents the user himself/herself. The first level of relationship has user elements 36, 37, 38 and is a closed community by requiring mutual relationships only, and not allowing access to other related elements via an intermediate user element of the first level. In an embodiment the relationship between two elements 36, 37 on the first level is made visible for the user 30. Hence living communities are formed and the visual channel may be used as a video-phone-like communication tool. A user would create his own ‘island’ with friends, and have no relation to the people they are connected to. In the figure Kim is connected to friend ‘G’, who is also connected to Peter, though, no second grade connection is made trough ‘G’ between them.

FIG. 4 shows visual structures for a personalized channel. FIG. 4a shows a home element 40 as a central element of the visual structure 45. Around the home element an annular area represents the first level of relational distance to the user, and the first level is subdivided in segments. A segment is showing a user element 41 on the first level by displaying some visual information provided by that user. A second adjacent annular area is more outward and displays user elements 42 of the second level of relational distance. Third level user elements 43 and a fourth level user elements 44 are shown in radially more outward laying position. The fifth and sixth annular areas 46 are very small, individual user elements can hardly be seen on these levels in this view. In an embodiment a segment of a higher level annular area is showing the user elements which have a relation to the home element via a user element in a corresponding intermediate more inward laying annular area. In a practical embodiment the visual structure is filled as follows. The structure is divided into 6 rings around a small circle 40. The first ring is divided into 4 parts which stands for 4 ‘friends’. The second ring contains the friend's friends, so this ring is divided in much more parts, say that every friend has 4 friends; then this ring contains 16 images. All the other rings are built up in the same way and the connections are made in the same way. The 4th, 5th and the 6th ring are all more or less the same. The user probably doesn't know the people in it; the only difference is that here is an exponentially growing number of images in every following ring.

FIG. 4b shows a visual structure similar to FIG. 4a, but the user has zoomed in on a different level. The width of the annular area 48 of the first level is much smaller than in FIG. 4a, while the width of annular area 47 of the second level has increased. In the embodiment the width of the annular area is determined by user commands, in particular by the user having indicated that he has selected that level of relational distance. FIG. 4c shows a visual structure similar to FIG. 4a, but the user has zoomed in on the third level. Hence the third level area 49 is expanded and the first and second level areas are collapsed.

In an embodiment the annular areas constitute a disc and are filled with user elements as follows. The available web cams are placed around the smallest circle; which corresponds with the home of the user. When this circle (basically level 0) is selected and zoomed in, the user can see what images are coming from his/her web cam. The disc is changing continuously. The first cause for the changing appearance is the fact that not everybody is ‘connected’ all the time and if someone isn't connected his/her user element is not shown. This means a change of one or two people in the first level has big consequences in the layout of the disc, and in the reach one has of connected people (one reaches far more people with 8 people in the first degree than with 3 people in the first degree). In an embodiment the device is arranged for showing a higher level of user elements including user elements based on the relationship with a user on a lower level that is not connected himself. Such a view would always show a larger number of user elements. The user may have the option of selecting such expanded view. Next to that the disc changes if the user changes degrees. The selected degree grows bigger so one can get a better view on what is happening in the selected image. The selected images is also bigger than the other images in the degree, otherwise the view would be so narrow that still nothing could be seen. The extra space for this bigger view is accomplished by making the ‘lower degrees’ smaller.

FIG. 5 shows a segment of a visual structure. The home element 40 is shown at the bottom of the display. The first level of user elements 41 is shown adjacently, and part of the second level of user elements 42 is shown in the upper part of the display. The middle part of the display shows an enlarged picture of a selected user element 50 of the first level. By applying search and zoom commands the user indicated that the visual structure has to be enlarged. This view is an enlarged part of the disc described above with FIG. 4, and the user can get a more informative look at certain places.

In embodiments below the relationship information and navigation through the visual structure is based on further user information. In a first embodiment geographical navigation is used. Several user parameters may be included in the relational distance calculation and levels may for example be based on: the connected people with the same area code, the connected people in the same city, the connected people in the same country, the connected people in the same continent; the connected people in the world. In a second embodiment called road-trip the geographical information is used to virtually make a trip. A user could pass all the connected houses on his way to -for example- Moscow, or Sydney. A user could even have connected cruise ships or trains to takes one trough deserted places or the ocean. As most people take planes to their destinations this road trip could give them a bit more ‘travel feeling’. In a third embodiment relational distance is based on choice criteria on people, for example age, sex, hair color, health condition, pets, location, etc. The user could zap from bus stops in Japan to Scotland to New York City to a little village in Spain. In a fourth embodiment navigation is based on circumstantial parameters, for example temperature, or light intensity. The user could navigate by such factors, e.g. go to places with the same temperature; or go to a place with a slightly higher temperature every step until the warmest place is reached. The user could also start with a pitch-black scene and go to a slightly lighter place step by step, until one has reached the place with the highest light intensity, and then go back. An automatic zap function could make such a cycle in 24 hours. Further the navigation can be dependent on movement; if nothing is moving in a scene of 30 seconds it zaps away to something else. What the user gets next may be random. Navigation could also be dependent on movement in the user's room. For example a user paying attention usually will be sitting still, so there is little movement in the room. Then the selected user element will not change. If there is movement in the room the personalized channel will zap around until it attracts the user's attention.

In an embodiment of the device the generating unit 23 for generating an output signal for display has a unit for combining locally stored visual information with visual information provided by the server entity. Hence the personalized visual channel displayed for the user is constituted by the combination. For example a map of the relevant area, locally stored in the user device, is used as background image for a visual structure provided by the server using navigation based on geographical information.

FIG. 6 shows a user command unit. The unit is implemented as a rectangular cabinet 61, having numerical buttons 62, directional button 63 and some special function buttons 64. Alternatively other shapes or types of user control buttons can be used. In particular the control of the personalized channel is executed using the buttons. The ‘MOVE’ button is used for navigating through the various visual sources within the personalized channel. For example the wheel-type visual structure described above with FIGS. 4 and 5 can be made to rotate visually. The rotating can be stopped by pushing the MOVE button again.

FIG. 7 schematically shows user command functions. The total set of user control functions 71 (remote-control buttons) is shown on the left. As a functional subdivision to the right the special functions 72 (view, menu, move, arrows) corresponding to the special function buttons 64 and the directional buttons 63 are shown. A further subdivision shows detailed functions 73 (over all, zoom in, full screen, disconnect, connect, private, sound, move, stop, right, left, down, up). The view button zooms in on the overview; in particular it zooms in around the selected image. One has to press the same button once, twice or three times to see these views. The connect function connects new ‘friends’, and the disconnect function disconnects old ones. The numerical buttons 62 on the remote control are also needed for selecting the person to be (dis-)connected. The private function only connects to the source of a selected image; other users cannot see the user. The move function sets the wheel starts to turn and provides automatically change of the selected images. If the user presses the button the visual structure moves; press it again and the wheel stops. The up and down arrow buttons change the layers in the wheel (up is level up, down is level down). The left and right buttons allow one to change images within the layers.

The sound function offers a choice for the sound that the user wants for the personalized visual channel. In different embodiments the sound function can be executed as follows. The visual channel without sound offers less companionship, and with sound it invades the privacy. The sound function is to either switch on the microphone on the camera or to not switch it on. When the microphone is switched on there is no problem; the user apparently doesn't have a problem with the privacy. When the microphone is switched off; there is no sound [and less company]. There are a number of possibilities that could take away that silence. For example: put the sound of another TV channel on, e.g. sound from MTV or CNN; scramble the noise so the user can't understand what is said but still hears something; put the sound from a local radio station on; the user come up with something from an external source. In an embodiment the users in the first degree have the option to overrule the sound selected, and call for the people trough the selected sound. This could give a surprising and spontaneous effect.

FIG. 8 shows alternative user command buttons. FIG. 8a shows a set of user buttons having a central zoom button 81. The directional buttons (level up, level down, left, right) are positioned around the central zoom button. The special function buttons (menu, move) positioned below the others. The zoom button corresponds with the selected image, when this button is pushed it zooms in on the selected image. The left, right, above and beneath button are organized in a way that corresponds with the visual structure on the display. The menu and move buttons are smaller, so the user feels the difference and the chance of accidentally pushing a wrong button is smaller. FIG. 8b shows a rotational button 82 and centered therein a zoom button 81. Above and beneath buttons ‘level up’ and ‘level down’ are for changing degrees. The middle button is for zooming in. Around the zoom button there is the disc 82 with which the user can ‘zap’ between the images in a layer. The buttons ‘move-stop’ and ‘menu’ are positioned to the sides and are for the menu and move functions, they are placed a bit further from the center so they are not accidentally pushed. FIG. 8c shows a game like user control unit. The unit is a maze 83 containing a ball and operates like a game; if the user rolls the ball into the next part on the left the visual structure goes one image to the left. The menu, the move and other function buttons are placed on a different location (not shown), e.g. on a separate remote control unit like the one shown in FIG. 7. FIG. 8d shows a ball shaped user control unit. A ball 84 has a second ball 85 inside the larger ball 84. The small ball 85 has a grid on it which corresponds with the visual structure on the display; the bigger ball 84 has a selector on it. By turning the ball the user can select new images.

Although the invention has been mainly explained by embodiments using a visual personalized channel on a TV system, the invention is also suitable for other display systems like a PC, mobile handsets, or any other rendering device. Further the user device or the server entity can be implemented on a computer system by a computer program for performing the required functions. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. System for controlling content of a personalized visual channel for at least one of a number of users, the users supplying visual information and being linkable via a network, which system comprises:
relationship means for maintaining relationship information that is indicative of a relational distance between the user and other users,
structure means for providing a visual structure for display within the personalized visual channel, the visual structure comprising
a home element representing a home location of the user, and
user elements, each user element representing one of the other users by said supplied visual information,
the user elements being positioned at a distance from the home element in dependence on the relationship information, and
control means for receiving user commands for controlling the structure means.

2. System as claimed in claim 1, wherein the relationship means are arranged for receiving the relationship information from the user based on an acquaintance between the user and said other user, and/or for establishing at least one next level of relational distance based on the relationship information supplied by other users.

3. System as claimed in claim 1, wherein the relationship means are arranged for applying the relationship information provided by the user for establishing the relationship information for an inverse relation of said other user to the user.

4. System as claimed in claim 1, wherein the relationship means are arranged for determining the relational distance based on at least one of the following user parameters: geographical position, age, personal interest, temperature, light intensity, time zone.

5. System as claimed in claim 1, wherein the structure means are arranged for creating at least one substantially annular area of user elements around a centrally located home element, the radial distance between the home element and the annular area corresponding to the relational distance.

6. System as claimed in claim 5, wherein the structure means are arranged for displaying in a segment of an annular area user elements according to relationship information of the user element occupying a corresponding segment of a radially inward adjacent annular area.

7. System as claimed in claim 5, wherein the structure means are arranged for determining the width of the annular areas and/or displaying an enlarged part of said structure in dependence of the user commands.

8. System as claimed in claim 5, wherein the structure means are arranged for displaying a selection of the user elements in said structure in dependence of at least one of the following: a link to the respective user being available; a timer function; detection of movement within the visual information of a user element.

9. System as claimed in claim 5, wherein the user control means are arranged for receiving a move command, and the structure means are arranged for moving the user elements in an annular area.

10. Device for providing a personalized visual channel for at least one of a number of users, the users supplying visual information and being linkable via a network, for cooperating with the system of claim 1, the device comprising
an input unit for receiving real time information from a capture unit, which real time information comprises video information related to the user,
storage means for storing user parameters identifying the user,
user control means for receiving user commands for controlling structure means for generating a visual structure for display within the personalized visual channel, the visual structure comprising
a home element representing a home location of the user, and
user elements, each user element representing one of the other users by said supplied visual information,
the user elements being positioned in the visual structure at a distance from the home element in dependence on the relationship information,
a network unit for coupling the device to the system via a network for transmitting the real time information and the use user parameters and user commands and for receiving the personalized visual channel, and
generating means for generating and output signal for display of the personalized visual channel.

11. Method of controlling content of a personalized visual channel for at least one of a number of users, the users supplying visual information and being linkable via a network, which method comprises:
maintaining relationship information that is indicative of a relational distance between the user and other users,
providing a visual structure for display within the personalized visual channel, the visual structure comprising
a home element representing a home location of the user, and
user elements, each user element representing one of the other users by said supplied visual information,
the user elements being positioned in the visual structure at a distance from the home element in dependence on the relationship information, and
receiving user commands for controlling the visual structure.

12. Method as claimed in claim 11, wherein the method comprises
providing user registration for users which are allowed to connect a user device to the system via the network for providing the personalized visual channel to the user, and
generating the user parameters identifying the user for user registration and for storage in the user device.

13. Computer program product for controlling content of a personalized visual channel, which program is operative to cause a processor to perform the method as claimed in claim 11.
